(19) United States
(12) Patent Application Publication
(10) Pub. No.: US 2009/0224901 A1
(43) Pub. Date: Sep. 10, 2009

(54) TIRE PRESSURE MONITORING SYSTEM WITH AN INTERMEDIATE BLUETOOTH INTERFACE

(75) Inventor: Hung-Chih YU, Taichung (TW)

Correspondence Address: Muncy, Geissler, Olds & Lowe, PLLC, P.O. BOX 1364, FAIRFAX, VA, 22038-1364, US

(73) Assignee: ORANGE ELECTRONIC CO., LTD., Taichung Hsien (TW)

(21) Appl. No.: 12/042,895

(22) Filed: Mar. 5, 2008

(51) Int. Cl. B60C 23/00

(52) U.S. Cl. 340/447

(57) ABSTRACT

A tire pressure monitoring system with an intermediate bluetooth interface has at least one character detector, an intermediate transceiver and a portable apparatus. The character detector is securely formed inside a tire of a vehicle, detects a tire pressure or an interior temperature inside the tire and sends out a low power consumption electromagnetic wave signal. The intermediate transceiver receives the low power consumption electromagnetic wave signals, transforms the low power consumption electromagnetic wave signals to bluetooth signals and sends out the bluetooth signals. The portable apparatus has a monitor, is portable and receives the bluetooth signals to display information corresponding to the tire pressure or the interior temperature of the tire on the monitor to a person.

### BACKGROUND OF THE INVENTION

1. Field of Invention

The present invention relates to a tire pressure monitoring system, and more particularly to a tire pressure monitoring system with a bluetooth interface.

2. Description of the Related Art

Car electronics have far improvement recently because people care about driving safety more and more nowadays. For instance, a tire pressure monitoring system (TPMS) is applied for monitoring air pressure inside tires of a vehicle. A conventional TPMS comprises four tire pressure detectors and a receiving apparatus. The tire pressure detectors are mounted on rims of four tires of a vehicle, continuously detect tire pressures inside the tires and send electromagnetic wave signals corresponding to the tire pressure. The receiving apparatus is securely mounted inside the vehicle, receives the electromagnetic wave signals sent from the detectors and has a monitor. The monitor displays the tire pressure conditions according to the electromagnetic wave signals to a driver.

However, reading of the information on the monitor is not available when a person stands outside the vehicle, and this causes troublesome when the person wants to adjust the tire pressure pressures with the instantaneous readings. Moreover, appearance and space of a dashboard of the vehicle may also be deteriorated because of the monitor is normally mounted securely on the dashboard.

To overcome issues described as above, a tire pressure monitoring system with bluetooth interfaces was provided. The tire pressure monitoring system with bluetooth interfaces has multiple tire pressure detectors and a portable monitoring system. Each tire pressure detectors has a bluetooth interface and sends detected tire pressure signal via the bluetooth interface to the portable monitoring system. The portable monitoring system may be a cell phone or a smart phone having a receiving bluetooth interface to receive the detected tire pressure signals from the tire pressure detectors and display the tire pressure conditions to the person. Hence, most of problems of the conventional TPMS are resolved.

However, power cells for the tire pressure detector have to be recharged or replaced frequently because the bluetooth interface has higher power consumption. Moreover, replacing a battery inside a tire pressure detector that mounted on a rim of a tire is very difficult and time consuming since the battery is securely sealed inside the tire pressure detector.

The present invention provides a tire pressure monitoring system with intermediate bluetooth interfaces to obviate or mitigate the shortcomings of the conventional tire pressure monitoring system with a bluetooth interface.

### SUMMARY OF THE INVENTION

The primary objective of the present invention is to provide a tire pressure monitoring system with an intermediate bluetooth interface to reduce power consumption and prolong a useful lifetime of a character detector of the tire pressure monitoring system.

The tire pressure monitoring system has at least one character detector, an intermediate transceiver and a portable apparatus. The character detector is securely mounted inside a tire of a vehicle, detects a tire pressure or an interior temperature inside the tire and sends out low power consumption electromagnetic wave signals. The intermediate transceiver receives the low power consumption electromagnetic wave signals, transforms the low power consumption electromagnetic wave signals thereby sends out bluetooth signals. The portable apparatus has a monitor, is portable and receives the bluetooth signals to display information corresponding to the tire pressure or the interior temperature of the tire on the monitor to a person.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a tire pressure monitoring system with an intermediate bluetooth interface in accordance with the present invention;

FIG. 2 is an operational top view of a car with the tire pressure monitoring system FIG. 1;

FIG. 2A is an enlarged top view of a tire with a character detector of the tire pressure monitoring system in FIG. 2; and

FIG. 3 is an enlarged side in partial section of the tire with the character detector in FIG. 2, showing the detector being mounted on a rim of a tire via a valve stem.

### DETAILED DESCRIPTION OF THE INVENTION

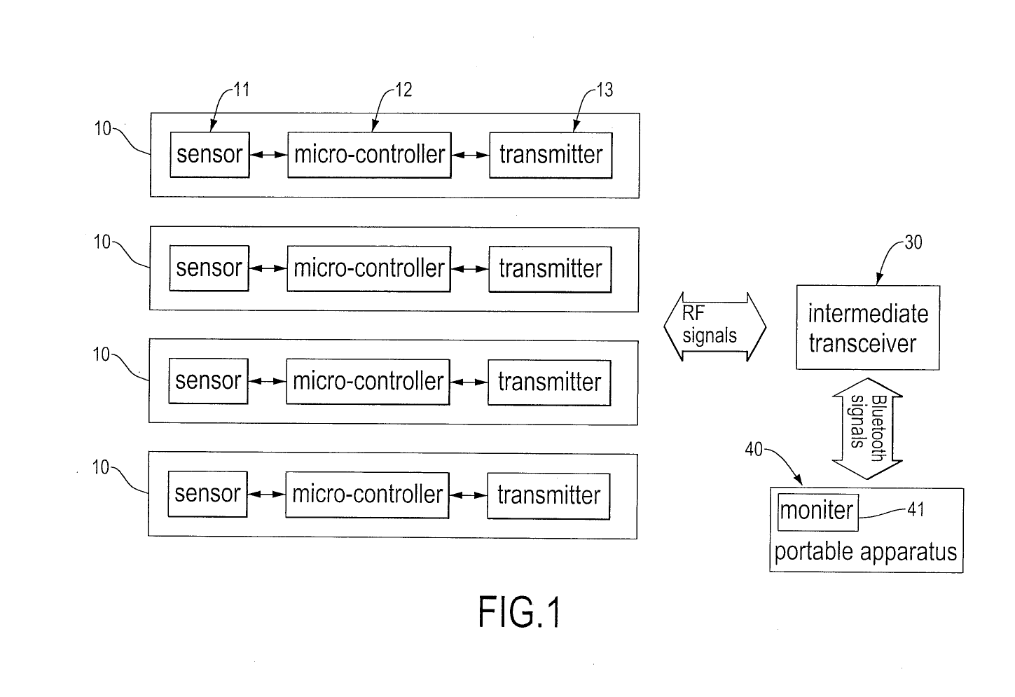

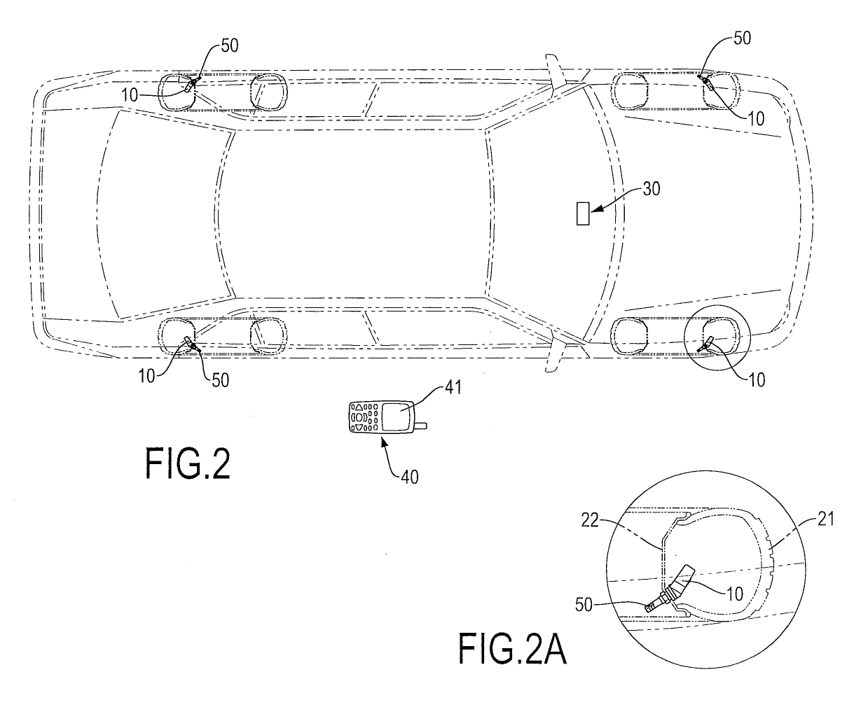

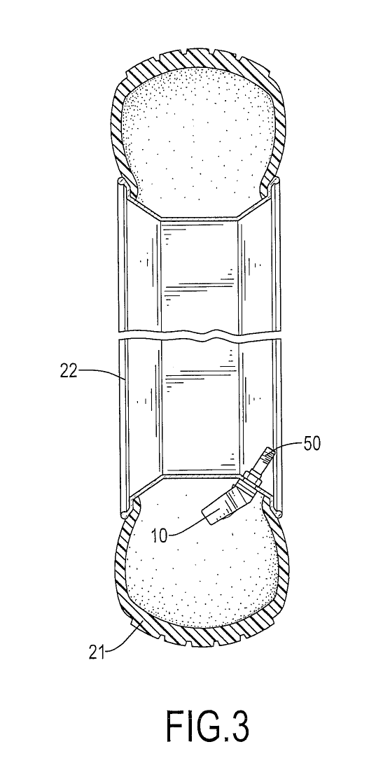

With reference to FIGS. 1, 2, 2A and 3, a tire pressure monitoring system with an intermediate bluetooth interface in accordance with the present invention comprises at least one character detector (10), an intermediate transceiver (30) and a portable apparatus (40).

Each character detector (10) is securely mounted on a valve stem (50) to be mounted on a rim (22) of a tire (21) and is placed inside the tire (21) to detect conditions inside the tire. The character detector (10) may be a tire pressure detecting electronic module and/or a tire temperature detecting module to respectively detect the conditions, such as tire pressures or interior temperatures inside the tire (21) and instantaneously and continuously transmits a low power consumption electromagnetic wave signal corresponding to the detected conditions. Each character detector (10) has a micro-controller (12), a sensor (11) and a transmitter (13).

The low power consumption electromagnetic wave signal is a non-bluetooth signal, may be an AM, FM or the like signals that have lower consumption during transmission.

The sensor (11) is electronically connected to the micro-controller (12), is controlled by the micro-controller (12) to continuously detect the tire pressure and/or the interior temperature in a corresponding tire and transmits the detected tire pressure and/or the interior temperature to the micro-controller (12).

The transmitter (13) is electronically connected to the micro-controller (12) and is controlled by the micro-controller (12) to continuously generate a low power consumption electromagnetic wave signal.

The intermediate transceiver (30) receives the low power consumption electromagnetic wave signals from the detectors (10), transforms the low power consumption electromagnetic wave signals to a bluetooth signal, and then sends out the bluetooth signal. The intermediate transceiver (30) may be rechargeable or plug-connected and may be mounted inside a glove compartment or under a seat in the vehicle.

The portable apparatus (40) is portable, may be a Personal Digital Assistant (PDA), a smart phone, portable phone, a notebook, a MP3 player or the like, has a monitor (41) and is capable of receiving the bluetooth signals from the intermediate transceiver (30) to continuously display information on the monitor (41) corresponding to the received bluetooth signals to a person holding or carrying the portable apparatus (40).

Because communications between the character detectors (10) and the intermediate transceiver (30) uses low power consumption electromagnetic wave signals for communication, power consumption of the character detector (10) is efficiently reduced so that to recharge or replace power cells for the character detectors (10) frequently is unnecessary. On the other hand, the person may easily maintain the intermediate transceiver (30) because the intermediate transceiver (30) is designed to be easily rechargeable or plug-connected and is placed inside the vehicle that is easily to get.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A tire pressure monitoring system comprising:
at least one character detector, being adapted to be located inside a tire for continuously detecting characters in the tire and instantaneously and continuously sending out a low power consumption electromagnetic wave signal corresponding to the characters and each having
a micro-controller;
a sensor being electronically connected to the micro-controller, being controlled by the micro-controller to continuously detect the using characters and transmitting the detected using characters to the micro-controller; and
a transmitter being electronically connected to the micro-controller and being controlled by the micro-controller to continuously generate a low power consumption electromagnetic wave signal, wherein the low power consumption electromagnetic is a non-bluetooth signal;
an intermediate transceiver continuously receiving the low power consumption electromagnetic wave signal sent from the at least one character detector and transforming the low power consumption electromagnetic wave signal to a bluetooth signal; and
a portable apparatus being portable, having a monitor and receiving the blue tooth signal form the intermediate transceiver to continuously display information on the monitor corresponding to the received bluetooth signal.

2. The tire pressure monitoring system as claimed in claim 1, wherein each one of the at least one character detector is a tire pressure detecting electronic module for detecting a tire pressure inside a tire.

3. The tire pressure monitoring system as claimed in claim 1, wherein each one of the at least one character detector is a tire temperature detecting electronic module for detecting an interior temperature inside a tire.

4. The tire pressure monitoring system as claimed in claim 2, wherein the intermediate transceiver is rechargeable.

5. The tire pressure monitoring system as claimed in claim 3, wherein the intermediate transceiver is rechargeable.

6. The tire pressure monitoring system as claimed in claim 2, wherein the intermediate transceiver is plug-connected.

7. The tire pressure monitoring system as claimed in claim 3, wherein the intermediate transceiver is plug-connected.

8. The tire pressure monitoring system as claimed in claim 4, wherein the portable apparatus is a Personal Digital Assistant.

9. The tire pressure monitoring system as claimed in claim 5, wherein the portable apparatus is a Personal Digital Assistant.

10. The tire pressure monitoring system as claimed in claim 6, wherein the portable apparatus is a Personal Digital Assistant.

11. The tire pressure monitoring system as claimed in claim 4, wherein the portable apparatus is a portable phone.

12. The tire pressure monitoring system as claimed in claim 5, wherein the portable apparatus is a portable phone.

13. The tire pressure monitoring system as claimed in claim 6, wherein the portable apparatus is a portable phone.

14. The tire pressure monitoring system as claimed in claim 4, wherein the portable apparatus is a MP3 player.

15. The tire pressure monitoring system as claimed in claim 5, wherein the portable apparatus is a MP3 player.

16. The tire pressure monitoring system as claimed in claim 6, wherein the portable apparatus is a MP3 player.
